(19) United States
(12) Patent Application Publication
(10) Pub. No.: US 2022/0220013 A1
(43) Pub. Date: Jul. 14, 2022

(54) FLUID FLOW MONITOR FOR WATER TREATMENT

(71) Applicant: Intex Industries Xiamen Co. Ltd., Fujian (CN)

(72) Inventors: Zhi Xiong HUANG, Fujian (CN); Yong Gui CHEN, Fujian (CN); Pei Lin CHEN, Fujian (CN)

(21) Appl. No.: 17/603,569

(22) PCT Filed: Apr. 15, 2020
(86) PCT No.: PCT/IB2020/053573

§ 371 Date: Oct. 13, 2021

(30) Foreign Application Priority Data
Apr. 17, 2019 (CN) 201920524170.8

(51) Int. Cl. C02F 1/68; C02F 1/467

(52) U.S. Cl. CPC C02F 1/686; C02F 2103/42; C02F 2201/46145; C02F 1/4674

(57) ABSTRACT

A water treatment system protects chlorine generator electrodes from miming dry. The system includes a water detection electrode (222) disposed above the chlorine generator electrode (223), and an outlet (12) at a height similar to the water detection electrode (222). If enough water is displaced from the housing (1) of the water treatment system by bubbles (4) generated by the energized chlorine generator, the water detection electrode (222) will cease to be bathed in water and will emit a signal indicative of this “dry” condition. The signal can be used to interrupt electrical power to the chlorine generator, thereby ensuring that the chlorine generator will not displace the water bathing it and therefore will not run dry.

### CROSS REFERENCE TO RELATED APPLICATION

This application claims priority to Chinese Patent Application No. CN201920524170.8, filed Apr. 17, 2019, the disclosure of which is hereby expressly incorporated by reference herein in its entirety.

### FIELD OF THE DISCLOSURE

The present disclosure relates to water treatment devices for use in pools, in particular to a pool water treatment device having a water flow monitoring system.

### BACKGROUND OF THE DISCLOSURE

Water treatment devices used for treating pool water may be installed at an upstream end of the water inlet to disinfect the water before it enters the pool. In jetted pools, the water inlets are typically the water jets, and adding chemicals to pool water at the water jet ensures that the chemical will be dispersed efficiently into moving water.

A common pool disinfectant is chlorine. Existing water treatment devices usually have a chlorine electrode set along the fluid flow path. In order to put a pool water treatment chemical into the water, the electrodes need to be connected to a power supply and turned on. Once the chlorine electrode is energized, it chemically reacts with the salt solute in the water, thus creating chlorine to treat the water.

However, these electrodes are energy inefficient because they cannot operate unless they are in flowing water, they cannot operate unless they receive a flow of electricity, and they cannot determine whether there is water flow. The result is that the electrodes are always on. This wastes energy and also increases the risk of damaging expensive water treatment equipment.

### SUMMARY

The present disclosure provides a water treatment system which protects chlorine generator electrodes from running dry. The system includes a water detection electrode disposed above the chlorine generator electrode, and an outlet at a height similar to the water detection electrode. If enough water is displaced from the housing of the water treatment system by bubbles generated by the energized chlorine generator, the water detection electrode will cease to be bathed in water and will emit a signal indicative of this “dry” condition. The signal can be used to interrupt electrical power to the chlorine generator, thereby ensuring that the chlorine generator will not displace the water bathing it and therefore will not run dry.

In one form thereof, the present disclosure provides a water treatment device including: a housing defining a chamber, the chamber having an inlet and an outlet disposed below the inlet; a fluid flow monitor disposed within the housing below the inlet; and a treatment chemical electrode disposed below the fluid flow monitor.

In another form thereof, the present disclosure provides a water treatment device including: a housing including a chamber; an inlet; an outlet; wherein the inlet and the outlet define a flow path through the housing; a treatment chemical electrode configured to be activated to provide a water treatment chemical into the flow path; and a fluid flow monitor configured to monitor a flow of liquid along the flow path, and to activate the treatment chemical electrode in a presence of fluid flow and to deactivate the treatment chemical electrode in an absence of fluid flow and when a fluid level within the housing drops below the outlet.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a top perspective view of a water treatment device made in accordance with the present disclosure;

FIG. 2 is an elevation, cross-sectional view of the water treatment device of FIG. 1;

FIG. 3 is another elevation, cross-sectional view of the water treatment device of FIG. 1, taken at a perpendicular to the view of FIG. 2;

FIG. 4 is an elevation view of the composite electrode group of the water treatment device of FIG. 1; and

FIG. 5 is an elevation, cross-sectional view of the water treatment device of FIG. 1 during operation and illustrating a flow of fluid.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

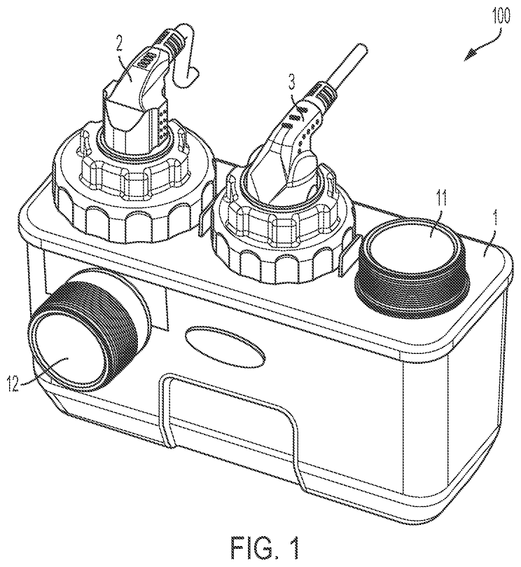

FIG. 1 illustrates an exemplary embodiment of a water treatment device 100 having a water flow detection system, such as for pools, spas or other bathing enclosures. As shown in FIG. 1, water treatment device 100 includes a device body or housing 1 having an inlet 11 and an outlet 12, a composite electrolytic assembly 2, and a water electrolytic assembly 3. Each of these components will be discussed in turn below.

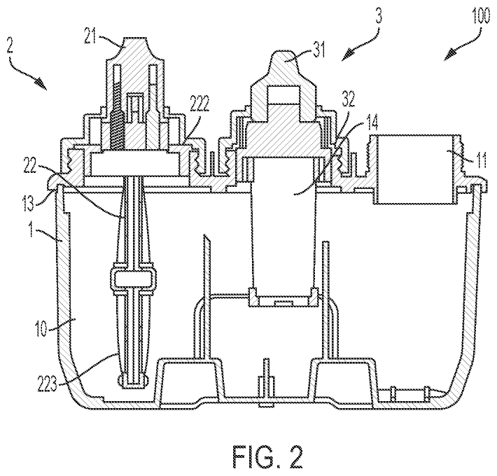

As shown in FIG. 2, device body 1 defines a chamber 10 forming an enclosure on all sides. In the illustrated embodiment, body 1 includes a bowl-shaped bottom portion and a lid which sealing interfits with the open top of the bottom portion. As best shown in FIGS. 1 and 2, the lid portion of device body 1 also includes a composite electrode aperture 13 (FIG. 2), a water electrode aperture 14 (FIG. 2), an inlet 11, and an outlet 12 (FIG. 1). Composite electrode aperture 13 and water electrode aperture 14 are formed side-by-side in the lid portion of device body 1 and, in the illustrated embodiment, are substantially the same size. Composite electrode aperture 13 is sized and configured to receive and sealingly couple to composite electrolytic assembly 2. Water electrode aperture 14 is sized and configured to receive and sealingly couple to water electrolytic assembly 3. In the embodiment shown in FIG. 2, composite electrode aperture 13 and water electrode aperture 14 include threaded surfaces to sealingly couple to composite electrolytic assembly 2 and water electrolytic assembly 3. Alternatively, they could include a snap-fit interface, or any other suitable sealed coupling method.

The device body 1 also includes water inlet 11 formed in the lid of body 1, and water outlet 12 formed in the bottom portion of body 1. Thus, as shown in FIG. 1, water inlet 11 is located higher than water outlet 12 to facilitate the flow of water and allow water to at least partially drain from the chamber 10 via outlet 12 when the water flow to inlet 11 stops. As described in detail below, the positions of inlet 11 and outlet 12 are configured to provide for selective fluid flow and retention that protects and facilitates the function of composite electrolytic assembly 2.

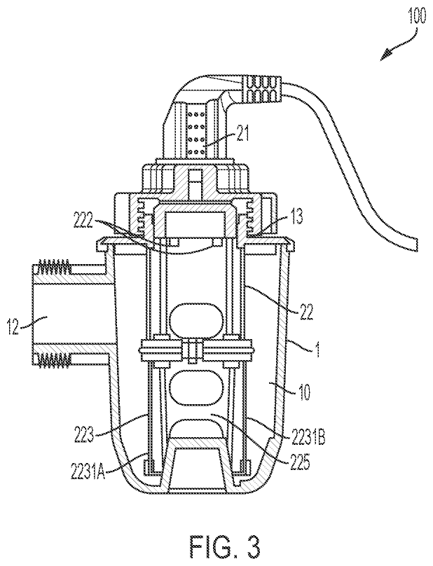

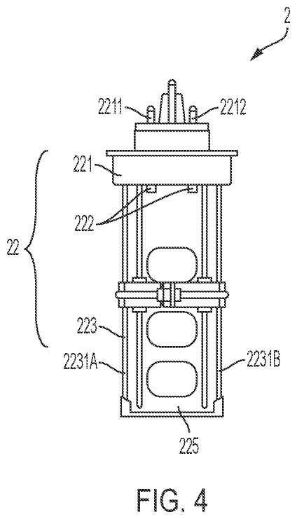

As shown in FIGS. 2-4, composite electrolytic assembly 2 includes composite electrode plug 21 (FIGS. 2 and 3), composite electrode group 22 including electrical connector 221 having a positive connector 2211 and a negative connector 2212 (FIG. 4), a water flow detection electrode 222 (FIG. 4), and a chlorine electrode group 223. Electrode groups 222, 223 of composite electrolytic assembly 2 are sized to be passed through composite electrode aperture 13, such that they extend substantially to the bottom of chamber 10. Electrical connector 221 extends above the top of device body 1, and does not pass through aperture 13.

Composite electrode plug 21 of composite electrolytic assembly 2 removably connects composite electrolytic assembly 2 to a source of electricity (not pictured) and optionally to a controller or other external electronic control device (not pictured). Composite electrode plug 21 is removably connected to composite electrolytic assembly 2 through electrical connector 221. Electrical connector 221 includes positive connector 2211 and negative connector 2212. FIGS. 2 and 3 show composite electrode plug 21 connected to electrical connector 221 and FIG. 4 shows composite electrode plug 21 disconnected from electrical connector 221. Although composite electrode plug 21 can physically connect and disconnect from composite electrolytic assembly 2, it is also configured to electrically disconnect from composite electrolytic assembly 2.

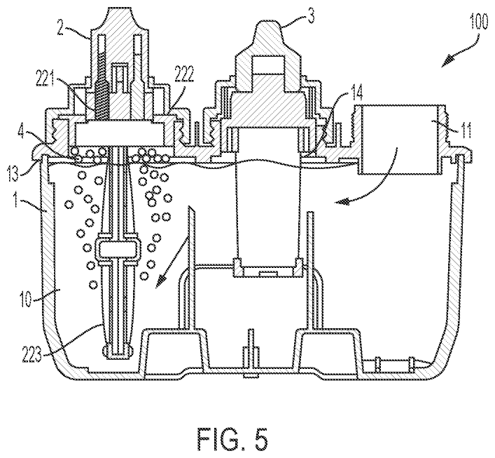

As mentioned above, composite electrolytic assembly 2 includes electrical connector 221 at a top potion, water flow detection electrode 222 at a middle portion, and chlorine electrode group 223 at a bottom portion. Water flow detection electrode 222 and chlorine electrode group 223 are both mounted upon and electrically connected to the electrical connector 221. Water flow detection electrode 222 is located vertically above chlorine electrode group 223. Chlorine electrode group 223 includes at least two titanium plates 2231A, 2231B (FIGS. 3 and 4) whose surfaces are coated with a coating configured to produce a water disinfectant in the presence of an electrical charge. For example, in one embodiment, the coating is for producing hypochlorite disinfectant when exposed to salt water and energized via an electrode. As the coating is exposed to salt water and energized, the coating begins to dissolve, and the resulting solution is hypochlorite. The chemical reaction with salt water also produces hydrogen gas which bubbles up through the water, as shown in FIG. 5 and further discussed below. Titanium plates 2231A, 2231B are fixed to chlorine electrode group 223 by a support frame 225.

Electrical connector 221 is provided with positive connector 2211 and negative connector 2212. Positive connector 2211 and negative connector 2212 are both connected to water flow detection electrode 222. Electrical connector 221 is configured to apply a low voltage to water flow detection electrode 222 through positive connector 2211 and negative connector 2212. Water flow detection electrode 222 is configured to react to an increase in water flow by increasing this voltage. Electrical connector 221 is configured to detect this voltage change to determine whether there is water flow in the vicinity of water flow detecting electrode 222. Chlorine electrode group 223 is electrically connected to the composite electrode plug 21.

Turning again to FIGS. 1 and 2, water electrolytic assembly 3 includes water electrolytic plug 31 and water electrode group 32. Water electrode group 32 is connected to water electrolytic plug 31. Water electrolytic plug 31 may be structured the same as, and may function similar to composite electrolytic plug 21. Similar to plates water electrode group 32 includes at least two titanium plates, supported by a support frame, whose surfaces are coated with a coating configured to electrolyze water to generate hydroxyl groups when the titanium plates are energized and in contact with water. Hydroxyl groups are known in the art to be a secondary pool water disinfectant. For example, during use, as water flows across the titanium plates hydroxyl groups will be produced between the plates to help disinfect the water. FIG. 2 shows water electrode group 32 schematically, it being understood that the arrangement of plates supported by a frame may be the same as plates 2231A, 2231B and support frame 225 of chlorine electrode group 223 shown in FIGS. 3 and 4.

Referring to FIG. 3 and FIG. 5, the working principle of the invention is as follows. Water flow enters from inlet 11 and flows out from outlet 12, such that the water in chamber 10 has constant flow therethrough. While the water is flowing, composite electrolytic assembly 2 and water electrolytic assembly 3 are energized. As water flows through chlorine electrode group 223, it generates bubbles 4 and a water disinfectant solution during electrolysis, as noted above. These bubbles 4 flow out of the chamber 10 together with the disinfectant solution as the water flows through outlet 12. If the water flow stops due to a ceasing of incoming water at inlet 11, a flow of fresh water to the part of chamber 10 containing the electrode groups 32, 222, and 223 no longer flows, though the electrodes may remain energized. In this configuration, the bubbles 4 generated by the chlorine electrode during electrolysis will gather and rise. Because outlet 12 is lower than inlet 11, bubbles 4 will displace water within chamber 10. Because outlet 12 is lower than inlet 11, it represents the path of least resistance such that the displaced water is routed through outlet 12. As the water level drops and bubbles 4 rise, water will be displaced from the vicinity of water flow detecting electrode 222.

When the water in the vicinity of the water flow detecting electrode 222 drops below a predetermined threshold level, electrode 222 produces a signal indicative of the lack of water. This signal may be a change in voltage or amperage, such as a drop to zero, or another predetermined minimum, or another signal. This signal is carried by the electrical connector 221 to a controller. The controller may be programmed to energize or otherwise activate electrodes 222 and 223 upon receipt of a signal that water treatment is desired, such as by an operator input or an automated indication of a need for water treatment. The controller is also programmed to de-energize or otherwise deactivate electrodes 222 and 223 by disconnecting the electrical connection between the power source and the composite electrolytic assembly 2 upon receipt of a signal that indicates water treatment is no longer needed, or that indicates water flow has stopped as further described herein. The controller may also activate and deactivate electrode 32 in a similar manner. This ceases the disinfection operation of the water treatment device 100.

Because water flow detection electrode 222 is disposed physically above the chlorine electrode group 223, and because electrical connector 221 detects and monitors the voltage of the water flow detection electrode 222 in real time, water treatment device 100 itself can monitor the state of the water flow in real-time with low cost. If electrode 222 registers a “dry” or low-water condition, it can de-energize electrode 223 (either directly or via the controller) before it would ever have a chance to be partially or entirely dry. In an exemplary embodiment, the controller may be programmed to allow activation of chlorine electrode group 223 when water flow detection electrode 222 signals the presence of water, subject to other conditions (e.g., a call for water treatment from a user or an automated controller logic function). The controller may also be programmed to prevent activation of chlorine electrode group 223 when water flow detection electrode 222 signals the absence of water, regardless of whether a call for water treatment is being issued.

This, in turn ensures that electrode 223 will always be fully submerged at any time that it is receiving electrical energy. This extends the life of pool water treatment device 100 by not allowing the composite electrolytic assembly 2 to continually run without water flow through housing 1.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A water treatment device comprising:
a housing defining a chamber, the chamber having an inlet and an outlet disposed below the inlet;
a fluid flow monitor disposed within the housing below the inlet; and
a treatment chemical electrode disposed below the fluid flow monitor.

2. The water treatment device of claim 1, wherein the fluid flow monitor is disposed above the outlet.

3. The water treatment device of claim 1, wherein the inlet and the outlet define a fluid flow path, the fluid flow monitor and the treatment chemical electrode disposed in the fluid flow path.

4. The water treatment device of claim 1, wherein the fluid flow monitor and the treatment chemical electrode are integrated into a composite electrolytic assembly.

5. The water treatment device of claim 4, wherein the composite electrolytic assembly further includes an electrode plug configured to connect the composite electrolytic assembly to a source of electricity.

6. The water treatment device of claim 5, further comprising a controller, the electrode plug connecting the composite electrolytic assembly to the controller.

7. The water treatment device of claim 4, further comprising a water electrolytic assembly disposed within the housing between the composite electrolytic assembly and the inlet.

8. The water treatment device of claim 7, wherein the treatment chemical electrode and the water electrolytic assembly each include at least two titanium plates having coated surfaces, the coated surfaces of the treatment chemical electrode configured to produce hypochlorite disinfectant and the coated surfaces of the water electrolytic assembly configured for electrolyzing water to generate hydroxyl groups.

9. The water treatment device of claim 1, further comprising a controller operably connected to the treatment chemical electrode, the controller programmed to activate the treatment chemical electrode upon receiving a treatment signal to provide a water treatment chemical to the outlet.

10. The water treatment device of claim 9, wherein the fluid flow monitor is configured to produce a flow signal indicative of a flow of liquid through the housing, the controller programmed to monitor the flow signal.

11. The water treatment device of claim 10, wherein the controller is programmed to allow activation of the treatment chemical electrode when the flow signal indicates a presence of fluid flow and prevent activation of the treatment chemical electrode when the flow signal indicates an absence of fluid flow.

12. The water treatment device of claim 11, wherein the controller prevents activation of the treatment chemical electrode by interrupting a flow of electricity to the treatment chemical electrode.

13. A water treatment device comprising:
a housing including a chamber;
an inlet;
an outlet;
wherein the inlet and the outlet define a flow path through the housing;
a treatment chemical electrode configured to be activated to provide a water treatment chemical into the flow path; and
a fluid flow monitor configured to monitor a flow of liquid along the flow path, and to activate the treatment chemical electrode in a presence of fluid flow and to deactivate the treatment chemical electrode in an absence of fluid flow and when a fluid level within the housing drops below the outlet.

14. The water treatment device of claim 13, wherein the treatment chemical electrode is disposed below the fluid flow monitor.

15. The water treatment device of claim 13, wherein upon deactivation of the treatment chemical electrode, the fluid flow monitor interrupts a flow of electricity to the treatment chemical electrode.

16. The water treatment device of claim 13, further including an electrode plug which removably connects the treatment chemical electrode to a source of electricity.

17. The water treatment device of claim 16, further comprising a controller, the electrode plug connecting the treatment chemical electrode to the controller.

18. The water treatment device of claim 13, further comprising a water electrolytic assembly disposed within the housing between the treatment chemical electrode and the inlet.

19. The water treatment device of claim 18, wherein the treatment chemical electrode and the water electrolytic assembly each include at least two titanium plates having coated surfaces, the coated surfaces of the treatment chemical electrode configured to produce hypochlorite disinfectant and the coated surfaces of the water electrolytic assembly configured for electrolyzing water to generate hydroxyl groups.

20. The water treatment device of claim 13, further comprising a controller operably connected to the treatment chemical electrode, the controller programmed to activate the treatment chemical electrode upon receiving a treatment signal to provide the water treatment chemical to the outlet.

21. The water treatment device of claim 20, wherein the fluid flow monitor is configured to produce a flow signal indicative of a flow of liquid through the housing, the controller programmed to monitor the flow signal.

22. The water treatment device of claim 21, wherein the controller is programmed to allow activation of the treatment chemical electrode when the flow signal indicates the presence of fluid flow and prevent activation of the treatment chemical electrode when the flow signal indicates the absence of fluid flow.

23. The water treatment device of claim 22, wherein the controller prevents activation of the treatment chemical electrode by interrupting a flow of electricity to the treatment chemical electrode.
